(19) United States
(12) Patent Application Publication
(10) Pub. No.: US 2020/0371899 A1
(43) Pub. Date: Nov. 26, 2020

(54) STATIC ANALYSIS OF CODE COVERAGE METRICS PROVIDED BY FUNCTIONAL USER INTERFACE TESTS USING TESTS WRITTEN IN METADATA

(71) Applicant: ADP, LLC, Roseland, NJ (US)

(72) Inventors: Mohammed Balal Ahmed, New York, NY (US); Richard A. Noad, New York, NY (US); Robert Wareham, Bristol (GB)

(21) Appl. No.: 16/422,502

(22) Filed: May 24, 2019

(51) Int. Cl. G06F 11/36

(52) U.S. Cl. CPC G06F 11/3676; G06F 11/3684

(57) ABSTRACT

A computer-implemented method for determining code coverage of an application under test (AUT) from automated tests includes obtaining, from a storage by a number of processors, metadata from the automated tests for the AUT. The metadata includes a test to be performed on a corresponding web page element. The method also includes identifying, by a number of processors, flow through the AUT made by the automated tests from the metadata. The method also includes determining, by a number of processors, a metric according to the flow through the AUT obtained from the metadata. The metric indicates a level of test coverage of the automated tests. The metric is determined statically from the metadata without executing the automated tests. The method also includes determining, by a number of processors, whether a threshold level of test coverage of the AUT has been reached according to the metric.

### BACKGROUND INFORMATION

### 1. Field

The present disclosure relates generally to an improved computer system and, in particular, to automated testing of web pages. More particularly, the present disclosure relates to determining code coverage of tests that test web pages and, even more particularly, to determining code coverage of tests for functional tests of user interfaces of web pages using tests written in metadata.

### 2. Background

Software testing is a process to evaluate the functionality of a software application with an intent to find whether the developed software meets specified requirements and to identify the defects in order to ensure that the produce is defect free in order to produce a quality product. Test coverage is an important part in software testing and software maintenance. Test coverage is the measure of the effectiveness of the testing. Test coverage is the amount of testing performed by a set of tests. Test coverage is a technique which determines whether a test actually covers the application code and how much of the code is exercised when a test is run. Current methods of measuring test coverage typically require that the entire test be executed and require significant time to complete. Additionally, during the time that the test is executed, the application under test is unavailable to other users.

### SUMMARY

An illustrative embodiment provides a computer-implemented method for determining code coverage of an application under test (AUT) from automated tests. The method includes obtaining, from a storage by a number of processors, metadata from the automated tests for the AUT. The metadata includes a test to be performed on a corresponding web page element. The method also includes identifying, by a number of processors, flow through the AUT made by the automated tests from the metadata. The method also includes determining, by a number of processors, a metric according to the flow through the AUT obtained from the metadata. The metric indicates a level of test coverage of the automated tests. The metric is determined statically from the metadata without executing the automated tests. The method also includes determining, by a number of processors, whether a threshold level of test coverage of the AUT has been reached according to the metric.

Another illustrative embodiment provides a system for determining code coverage of an application under test (AUT) from automated tests. The system includes a bus system, a storage device connected to the bus system, wherein the storage device stores program instructions, and a number of processors connected to the bus system. The number of processors execute the program instructions to obtain metadata from the automated tests for the AUT wherein the metadata includes a test to be performed on a corresponding web page element. The number of processors also execute the program instructions to identify flow through the AUT made by the automated tests from the metadata. The number of processors also execute the program instructions to determine a metric according to the flow through the AUT obtained from the metadata. The metric indicates a level of test coverage of the automated tests. The metric is determined statically from the metadata without executing the automated tests. The number of processors also execute the program instructions to determine whether a threshold level of test coverage of the AUT has been reached according to the metric.

Yet another illustrative embodiment provides a computer program product for determining code coverage of an application under test (AUT) from automated tests. The computer program product includes a non-volatile computer readable storage medium having program instructions embodied therewith. The program instructions are executable by a number of processors to cause the computer to perform a number of steps. The steps include obtaining metadata from the automated tests for the AUT. The metadata includes a test to be performed on a corresponding web page element. The steps also include identifying flow through the AUT made by the automated tests from the metadata. The steps also include determining a metric according to the flow through the AUT obtained from the metadata. The metric indicates a level of test coverage of the automated tests. The metric is determined statically from the metadata without executing the automated tests. The steps also include determining whether a threshold level of test coverage of the AUT has been reached according to the metric.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of an information environment in accordance with an illustrative embodiment;

FIG. 2 is a block diagram of an automated web page testing is in accordance with an illustrative embodiment;

FIG. 3 is a flowchart depicting a standard process for generating code coverage of an application under test (AUT) from automated tests in accordance with the prior art;

FIG. 4 is a flowchart depicting a process for generating code coverage of an AUT from automated tests in a metadata driven platform in accordance with an illustrative embodiment;

FIG. 5 is a flowchart depicting a process for generating code coverage of an AUT from automated tests in a metadata driven platform in accordance with an illustrative embodiment; and

FIG. 6 is a block diagram of a data processing system in accordance with an illustrative embodiment.

### DETAILED DESCRIPTION

The illustrative embodiments recognize and take into account one or more different considerations. The illustrative embodiments further recognize and take into account that unit tests execute the source code directly rather than in a deployed environment and, as such, there are many tools to measure the coverage generated. The process is simplified by the fact that the test and source code are executed within the same process. However, the illustrative embodiments further recognize and take into account that calculating test coverage for functional tests is a more difficult challenge because the test and source are executing in different processes and often are in different frameworks and languages. The illustrative embodiments further recognize and take into account that there currently exits tooling to provide orchestration of the deployed source code to observe which lines of code are executed while functional tests are executed, but these toolings are complex, require redeployment of source code, and an isolated environment. Accordingly, the full execution of these tests therefore are slow. Furthermore, the illustrative embodiments recognize and take into account that an application under test is unavailable to other users when a test is executed and that prior art test coverage methods require the test to fully execute in order to determine test coverage.

The illustrative embodiments provide a process for measuring test coverage of both unit tests and functional tests with static analysis. The illustrative embodiments provide that functional tests are stored in the same JSON format as all other Metadata Objects (MDOs). The illustrative embodiments provide that the test is constructed of test steps, each indicating which MDO identifier should be interacted with. The illustrative embodiments provide that by writing database queries against the Metadata JSON store, a correlation between which MDO are interacted with by a functional test can be obtained and, therefore, produce a coverage metric. The illustrative embodiments provide that by querying several levels deep, a picture of coverage beyond the interactions defined in the functional test is obtained. The illustrative embodiments provide that test coverage is determined without executing the test and without making the application under test unavailable to other users while determining the test coverage.

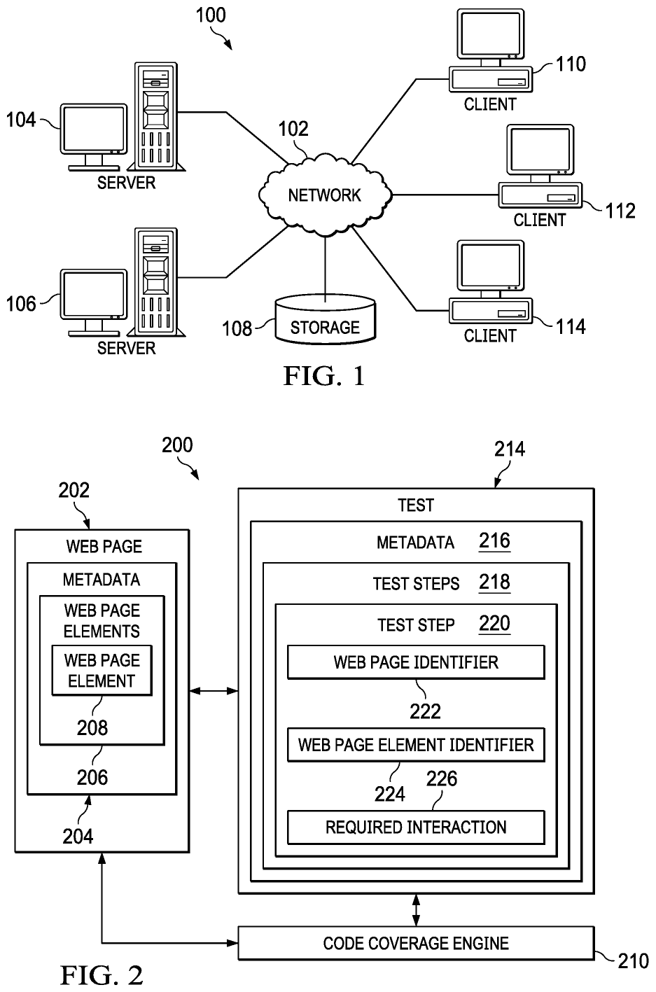

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Turning to FIG. 2, a block diagram of an automated web page testing system is depicted in accordance with an illustrative embodiment. System 200 comprises web page 202 that is under development. Web page 200 is defined by metadata 204 that includes multiple page elements 206 such as images, structured documents, and interactive forms. In an embodiment, metadata is data that provides information about other data describing, for example, a resource's purpose, function, interaction with other data, identity, author, and/or other characteristics.

The functionality in web page 202 is provided by web page elements 206 defined within metadata 204. An example of web page element 206 is a drop-down menu that a user activates by holding a cursor over and/or clicking on it.

Automated testing of web page 202 is provided by a test engine (not shown) that performs test 214 on web page 202. The details of the automated testing and the test engine are beyond the scope of this disclosure. Test 212 comprises multiple test steps 218, which are metadata objects defined within metadata 216 of test 214. Each web page element 208 has a corresponding test step 220. Each test step 220 comprises a unique web page identifier 222 and a unique web page element identifier 224. Each web page identifier 222 and each web page element identifier 224 are unique to the page and element. In other words, in an embodiment, the same web page identifier 222 and the web page element identifier 224 are reused if a test step references the same page or element again. Furthermore, in an embodiment, this is true for test steps across different tests. Test step 220 also comprises required interaction 226 including any data necessary to achieve it. For example, a “Set Value” interaction also requires the value to be set, whereas a Click interaction requires no other data.

Instead of storing code for each test step 220, the illustrative embodiments store the test step as a metadata object. Metadata 216 embodies the intent behind each test step 220, which allows the entire structure of web page 200 to change hierarchically and stylistically and for test step 220 to automatically adapt at runtime without a need for offline refactoring.

Code coverage engine 210 analyzes test 214 to determine code coverage of test 214 for the application under test (e.g., web page 202). Code coverage engine 21 queries metadata 216 to find all references (i.e., flow through the AUT) made by test 214. These references (flow through the AUT) include test steps 218, test step 220, web page identifier 222, web page element identifier 224, and required interaction 226. Code coverage engine 210 also queries web page metadata 204 to determine whether web page element 208 is covered by test 214. From the references made by the automated tests, code coverage engine 210 generates metrics indicating the amount of code coverage provided by test 214. If a threshold level of code coverage has not been reached, then the developer may write additional automated tests in metadata to try to improve test coverage. The determination of how much code coverage is provided by the test is made from querying the metadata and without actually running the test or the application under test. This saves time in determining whether the test completely covers the application under test. Once the tests have been created, the procedures described below can be utilized to determine the code coverage of the AUT.

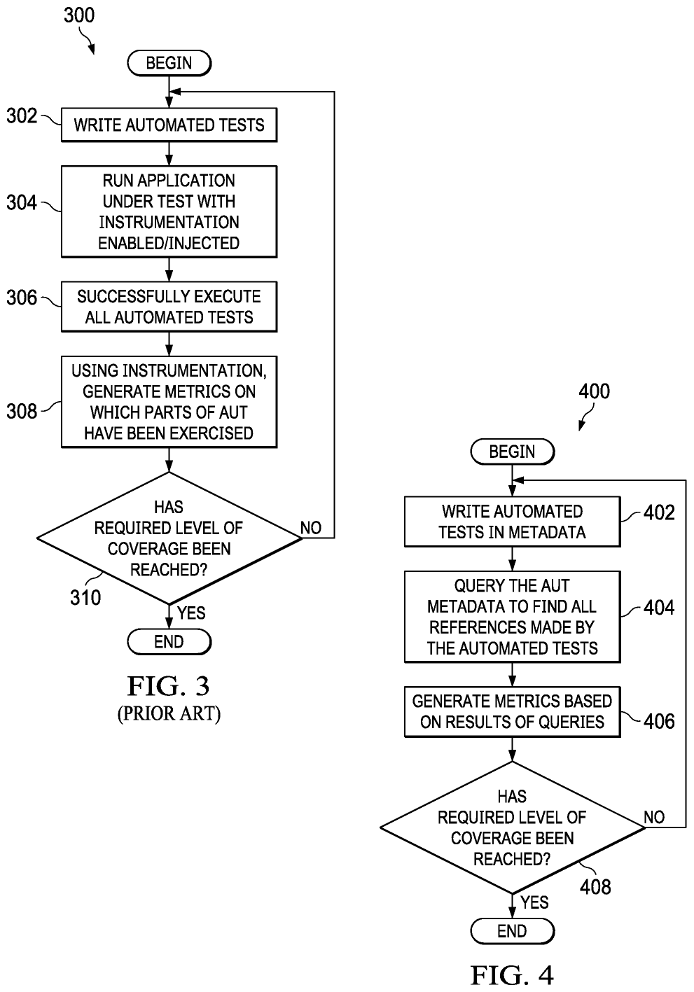

FIG. 3 is a flowchart depicting a standard prior art process for generating code coverage of an application under test (AUT) from automated tests in accordance with the prior art. Process 300 begins with the developer writing automated tests for the AUT (step 302). Code coverage is normally restricted to “unit” tests. A unit test is a test that tests an individual unit such as a method (function) in a class with all dependencies mocked up. Functional tests such as UI or API are more difficult to calculate code coverage for. A functional test is also known as an integration test and it tests a slice of functionality in a system. Thus, in an embodiment, a functional test will test many methods and may interact with dependencies such as databases or web services. Next, the developer runs the AUT with instrumentation enabled/injected (step 304). Instrumentation of the executing code is achieved by the use of third-party libraries. It is easier for “unit” testing because the code is directly instantiated by the test. For functional tests, the entire application must be instrumented.

Next, successfully execute all automated tests (step 306). One disadvantage of process 300 is that the process is dynamic in that it requires both the AUT and the tests to be executed. Another disadvantage is that the feedback loop is only as fast as the test execution time. Furthermore, if functional test coverage is being attempted, then all other users of the AUT must be disabled while the tests are executed.

Next, using instrumentation, generate metrics on which parts of AUT have been exercised (step 308). Open source tools such as Jest (Javascript), NCover (C#) and JCov (Java) will perform the instrumentation and metric reporting. Next, process 300 determines whether the required level of coverage has been reached (step 310). If not, then process 300 proceeds to step 302. A further disadvantage of the prior art is that any attempt to improve coverage with updated or new tests will require the entire test suite to be re-run.

This prior art method of determining code coverage of the AUT suffers from a number of disadvantages. For example, process 300 is dynamic and requires that all tests be fully executed which is time consuming. Thus, the time to determine code coverage of the AUT is at least the time taken to run all tests. Therefore, potential coverage is not known until all tests have successfully executed. Furthermore, process 300 requires third party tooling to instrument application to monitor execution paths. Additionally, process 300 and similar prior art procedures are difficult to apply to functional tests as the entire AUT must be instrumented and isolated.

FIG. 4 is a flowchart depicting a process for generating code coverage of the AUT from automated tests in a metadata driven platform in accordance with an illustrative embodiment. Process 400 begins with the developer writing automated tests for the AUT in metadata (step 402). The tests are stored in the same format as every other part of the platform. The tests describe the events they are triggering with direct reference to the metadata that describes the platform. Next, process 400 queries the AUT metadata to find all references made by the automated tests (step 404). In an embodiment, all metadata is written to the same data storage, therefore, allowing complete data queries to be written. The Queries may include client side execution (i.e., UI tests) which would normally, in the prior art, require instrumentation of the client as well as the AUT. However, embodiments of this disclosure eliminate the need for instrumentation of the client in order to check for test coverage of client side execution. Next, process 400 continues by generating metrics based on the results of queries (step 406). The metrics may be applied through the hierarchy of the AUT, not just those that are directly consumed by a test. For example, a client side test can click a button that triggers a server side process that writes to a persistence table. Therefore, process 400 may assert coverage through the entire application from a high level test without execution or instrumentation. Finally, process 400 determines whether a required level of coverage has been reached (step 408). If the required level of coverage has not been reached, then process 400 proceeds back to step 402 where the developer writes additional tests in metadata. In an embodiment, the impact of any attempt to improve coverage with updated or new tests can be viewed in near real time because there is no requirement to re-execute any tests. If the required level of coverage has been reached, then process 400 may end.

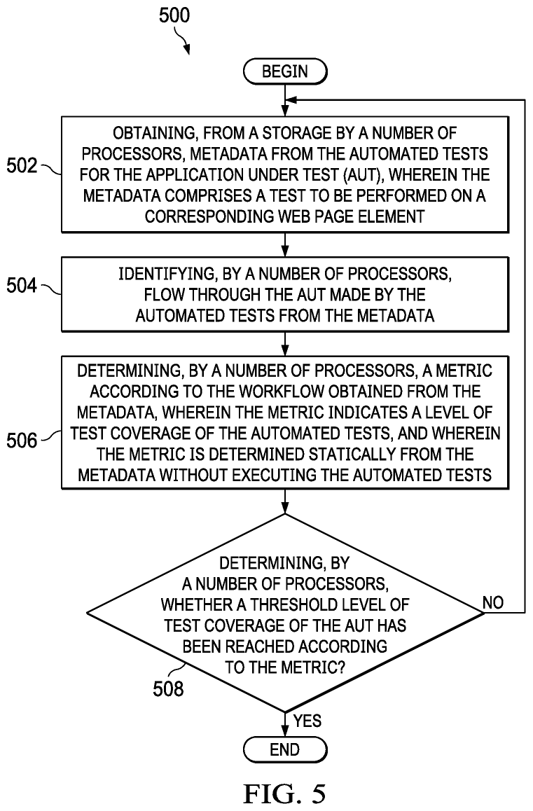

FIG. 5 is a flowchart depicting a process for generating code coverage of the AUT from automated tests in a metadata driven platform in accordance with an illustrative embodiment. Process 500 begins by obtaining, from a storage by a number of processors, test metadata from the automated tests for the application under test (AUT), wherein the test metadata comprises a test to be performed on a corresponding web page element (step 502). In an embodiment, the test metadata includes an object identifier of a web page element, an object identifier of a web page tile in which the element exists, and a name of an interaction to perform with the element. In an embodiment, the test metadata is independent of a web page interface. In an embodiment, the object identifier of the element is identified according to the metadata of the tile.

Next, process 500 continues by identifying, by a number of processors, flow through the AUT made by the automated tests from the test metadata (step 504). Identifying the flow through the AUT may include identifying flow through the AUT to be executed on a client side. In an embodiment the flow through the AUT includes server side flows through the AUT triggered by a client side test. In an embodiment, the flow through the AUT may include client side flow through the AUT triggered by a server side test.

In an embodiment, the tests are written in metadata and creating the tests includes specifying, by a number of processors, a number of tests for web page elements, wherein each test defines a control and a trigger event. Creating the tests may also include storing, by a number of processors, each test as an object obtaining a unique metadata identifier and a required event for the test. Creating the tests may also include, selecting, by a number of processors, a test from the number of tests to perform on a web page element and extracting, by a number of processors, metadata for the selected test according to its unique identifier.

Next, process 500 continues by determining, by the number of processors, a metric according to the flow through the AUT obtained from the test metadata, wherein the metric indicates a level of test coverage of the automated tests, and wherein the metric is determined statically from the test metadata without executing the automated tests (step 506). Next, process 500 continues by determining, by a number of processors, whether a threshold level of test coverage of the AUT has been reached according to the metric (step 508). The threshold level is implementation dependent and is typically determined by the user creating the test. If a threshold level of test coverage of the AUT has not been reached, then process 500 proceeds to step 502. In an embodiment, process 500 includes adding one or more additional tests to the automated tests when the threshold level of test coverage has not been reached and then determining whether the additional test improves the test coverage without re-executing a test. If a threshold level of test coverage of the AUT has been reached, then process 500 may end.

The following example may further explain the processes described herein. Consider user interface (UI) tests that interacts with Button B on Page A. One can say that Button B is covered by a functional test. However, by looking at Button B by interrogating the Page A MDO, one can see that Button B on Page A triggers Server Side Process C. Therefore, one can say that Server Side Process C is also covered by a functional test. By querying Server Side Process C, one can get an understanding of what other functionality described by MDOs is executed and therefore covered, and so on.

It should be noted that the disclosed processes for determining code coverage of tests for an AUT does not deploy or execute either the test or the platform and the metric is entirely generated by static analysis. Furthermore, querying will also allow for the measurement of selected options. For example, if there is a page element with values “True” and “False”, it can be ensured that there are tests which cover both scenarios. The disclosed processes and systems allow users, after having used their best judgement to create automated tests, to view any areas of their application that were not covered by automated tests, thereby reducing the potential risk of untested features and therefore, leading to better quality applications.

Illustrative embodiments provide the technical improvement of querying static metadata and not requiring all tests be fully executed. Thus, the time taken to determine code coverage of AUT is only the time taken for queries to execute. Illustrative embodiments also provide the technical improvement that potential coverage from all tests can be calculated. Furthermore, combining the potential coverage with the results of execution may provide a true coverage. Thus, illustrative embodiments are not reliant on successfully execution of the tests to determine code coverage. Illustrative embodiments also provide that instrumentation of the AUT is not required as no tests are executed to determine code coverage. Illustrative embodiment also provide that by traversing metadata, one can obtain coverage achieved by functional tests in addition to coverage achieved by “unit” tests.

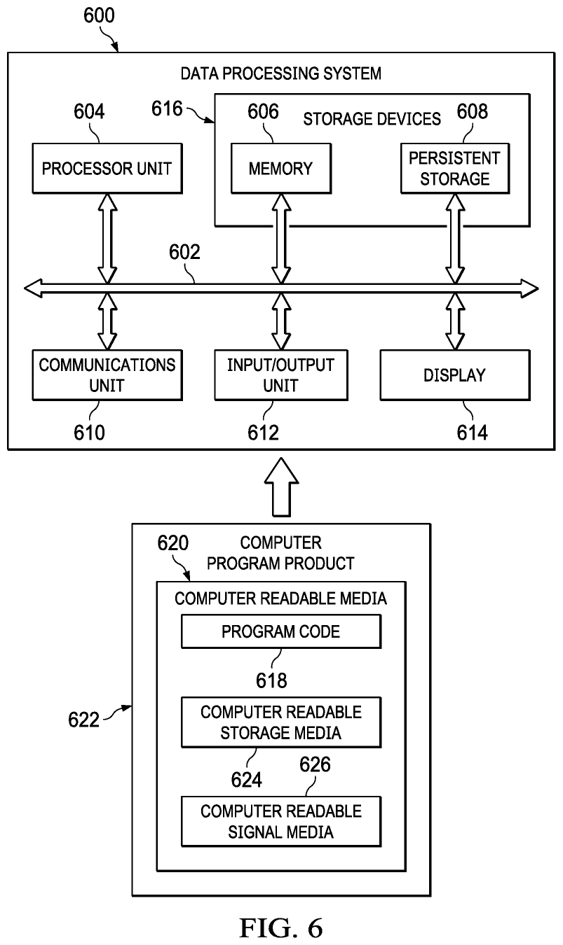

Turning now to FIG. 6, an illustration of a block diagram of a data processing system is depicted in accordance with an illustrative embodiment. Data processing system 600 may be used to implement one or more computers and client computer system 62 in FIG. 1. In this illustrative example, data processing system 600 includes communications framework 602, which provides communications between processor unit 604, memory 606, persistent storage 608, communications unit 610, input/output unit 612, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation. In an embodiment, processor unit 604 comprises one or more conventional general purpose central processing units (CPUs). In an alternate embodiment, processor unit 604 comprises one or more graphical processing units (CPUs).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 616, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Alternatively, program code 618 may be transferred to data processing system 600 using computer-readable signal media 626.

Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A computer-implemented method for determining code coverage of an application under test (AUT) from automated tests, the method comprising:
obtaining, from a storage by a number of processors, metadata from the automated tests for the AUT, wherein the metadata comprises a test to be performed on a corresponding web page element;
identifying, by a number of processors, flow through the AUT made by the automated tests from the metadata;
determining, by a number of processors, a metric according to the flow through the AUT obtained from the metadata, wherein the metric indicates a level of test coverage of the automated tests, and wherein the metric is determined statically from the metadata without executing the automated tests; and
determining, by a number of processors, whether a threshold level of test coverage of the AUT has been reached according to the metric.

2. The method of claim 1, wherein the identifying the flow through the AUT includes identifying flow through the AUT to be executed on a client side.

3. The method of claim 1, further comprising:
adding an additional test to the automated tests; and
determining whether the additional test improves the test coverage without re-executing at least one of the test or the additional test.

4. The method of claim 1, wherein the flow through the AUT includes server side flow through the AUT triggered by a client side test.

5. The method of claim 1, wherein the flow through the AUT includes client side flow through the AUT triggered by a server side test.

6. The method of claim 1, further comprising:
specifying, by a number of processors, a number of tests for web page elements, wherein each test defines a control and a trigger event;
storing, by a number of processors, each test as an object containing a unique metadata identifier and a required event for the test;
selecting, by a number of processors, a test from the number of tests to perform on a web page element; and
extracting, by a number of processors, metadata for the selected test according to its unique identifier.

7. The method of claim 1, wherein test metadata comprises:
an object identifier of a web page element;
an object identifier of a web page tile in which the elements exists; and
a name of an interaction to perform with the element.

8. The method of claim 7, wherein the test metadata is independent of a web page interface.

9. The method of claim 7, wherein the object identifier of the element is identified according to metadata of the web page tile.

10. A system for determining code coverage of an application under test (AUT) from automated tests, the system comprising:
a bus system;
a storage device connected to the bus system, wherein the storage device stores program instructions; and
a number of processors connected to the bus system, wherein the number of processors execute the program instructions to:
obtain metadata from the automated tests for the AUT, the metadata comprising a test to be performed on a corresponding web page element;
identify flow through the AUT made by the automated tests from the metadata;
determine a metric according to the flow through the AUT obtained from the metadata, wherein the metric indicates a level of test coverage of the automated tests, and wherein the metric is determined statically from the metadata without executing the automated tests; and
determine whether a threshold level of test coverage of the AUT has been reached according to the metric.

11. The system of claim 10, wherein the identifying the flow through the AUT includes identifying flow through the AUT to be executed on a client side.

12. The system of claim 10, wherein the number of processors further execute the program instructions to:
add an additional test to the automated tests; and
determine whether the additional test improves the test coverage without re-executing at least one of the test or the additional test.

13. The system of claim 10, wherein the flow through the AUT includes server side flows through the AUT triggered by a client side test.

14. The system of claim 10, wherein the flow through the AUT includes client side flow through the AUT triggered by a server side test.

15. The system of claim 10, wherein the number of processors further execute the program instructions to:
specify a number of tests for web page elements, wherein each test defines a control and a trigger event;
store each test as an object containing a unique metadata identifier and a required event for the test;
select a test from the number of tests to perform on a web page element; and
extract metadata for the selected test according to its unique identifier.

16. The system of claim 10, wherein test metadata comprises:
an object identifier of a web page element;
an object identifier of a web page tile in which the elements exists; and
a name of an interaction to perform with the element.

17. The system of claim 16, wherein the test metadata is independent of a web page interface.

18. The system of claim 16, wherein the object identifier of the element is identified according to metadata of the web page tile.

19. A computer program product for determining code coverage of an application under test (AUT) from automated tests, the computer program product comprising:
a computer readable storage media having program instructions embodied therewith, the program instructions executable by a number of processors to cause the computer to perform the steps of:
obtaining metadata from the automated tests for the AUT, the metadata comprising a test to be performed on a corresponding web page element;
identifying flow through the AUT made by the automated tests from the metadata;
determining a metric according to the flow through the AUT obtained from the metadata, wherein the metric indicates a level of test coverage of the automated tests, and wherein the metric is determined statically from the metadata without executing the automated tests; and
determining whether a threshold level of test coverage of the AUT has been reached according to the metric.

20. The computer program product of claim 19, wherein the identifying the flow through the AUT includes identifying flow through the AUT to be executed on a client side.

21. The computer program product of claim 19, wherein the program instructions further comprise program instructions executable by a number of processors to cause the computer to perform the steps of:
adding an additional test to the automated tests; and
determining whether the additional test improves the test coverage without re-executing at least one of the test or the additional test.

22. The computer program product of claim 19, wherein the flow through the AUT includes server side flows through the AUT triggered by a client side test.

23. The computer program product of claim 19, wherein the flow through the AUT includes client side flow through the AUT triggered by a server side test.

24. The computer program product of claim 19, wherein the program instructions further comprise program instructions executable by a number of processors to cause the computer to perform the steps of:
specifying, by a number of processors, a number of tests for web page elements, wherein each test defines a control and a trigger event;
storing, by a number of processors, each test as an object containing a unique metadata identifier and a required event for the test;
selecting, by a number of processors, a test from the number of tests to perform on a web page element; and
extracting, by a number of processors, metadata for the selected test according to its unique identifier.

25. The computer program product of claim 19, wherein test metadata comprises:
an object identifier of a web page element;
an object identifier of a web page tile in which the elements exists; and
a name of an interaction to perform with the element.

26. The computer program product of claim 25, wherein the test metadata is independent of a web page interface.

27. The computer program product of claim 25, wherein the object identifier of the element is identified according to metadata of the web page tile.
